(19) United States
(12) Patent Application Publication
(10) Pub. No.: US 2011/0219394 A1
(43) Pub. Date: Sep. 8, 2011

(54) REMOTE AUDIENCE PARTICIPATION

(76) Inventors: Jacquelynn R. Lueth, Encino, CA (US); Adit Reddy, Asheville, NC (US); William Garnet, Encino, CA (US)

(21) Appl. No.: 12/717,921

(22) Filed: Mar. 4, 2010

(51) Int. Cl. H04N 7/173; H04N 7/025

(52) U.S. Cl. 725/24; 725/34

(57) ABSTRACT

The present disclosure generally provides a system and method of interactive technologies to engage remote audiences to distract, confuse, impact, instruct, command, or otherwise positively or negatively affect participants of, for example, television shows, theater shows, or webcasts in real-time. In one example, an audience member could distract or otherwise confuse a participant of the show in real-time by calling a phone number, submitting information online, or text messaging. The participant (and perhaps fellow participants) could hear or view the message from the audience member as it is being submitted or shortly thereafter. In other cases, the call or online submission could trigger another distraction such as a digital display having a moving confusing pattern of some sort. With each additional call or online submission, the moving pattern could get more intense.

The disclosure relates generally to entertainment services and, in particular, to systems of remote audience participation.

### BACKGROUND

Television and, in particular, reality programming have recently become very popular. Some reality shows, game shows, and other programming include audience participation in voting and judging. What is needed, however, is a system of providing interactive technologies to engage remote audiences to participate or otherwise distract, confuse, impact, instruct, command, or otherwise positively or negatively affect participants of such shows in, for example, real-time.

### SUMMARY

Embodiments of the present disclosure generally provide a system of interactive technologies to engage remote audiences to distract, confuse, impact, instruct, command, or otherwise positively or negatively affect participants of, for example, television shows, theater shows, or webcasts in real-time.

In one embodiment, the present disclosure could generally provide a remote audience participation system. The system could include a server to process incoming information from one or more remote devices. The system could also include an impacting device in communication with the server to output a distraction to a selected participant of a show based on the incoming information.

In one embodiment, the present disclosure could generally provide a remote audience participation system. The system could include a server to process incoming information from one or more remote devices. The system could also generally include an impacting device in communication with the server to output a distraction to a selected participant of a show according to aggregate characteristics of the incoming information in real-time.

In one embodiment, the present disclosure could generally provide a remote audience participation system for use with a television show. The system could include a server to process incoming information from one or more remote devices controlled by an audience member. The server tallies the number of votes for a television participant. The system also includes an impacting device in communication with the server to output a distraction to a selected participant according to the number of votes. Alternatively, the system could include an impacting device to distract, confuse, impact, instruct, command, or otherwise positively or negatively affect participants of such shows.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 is a somewhat simplified illustration of the system of providing remote audience participation to distract or confuse a show member according to one embodiment of the present disclosure.

### DETAILED DESCRIPTION

Embodiments of the present disclosure generally provide a system of interactive technologies to engage remote audiences to distract, confuse, impact, instruct, command, or otherwise positively or negatively affect participants of, for example, television shows, theater shows, or webcasts in real-time.

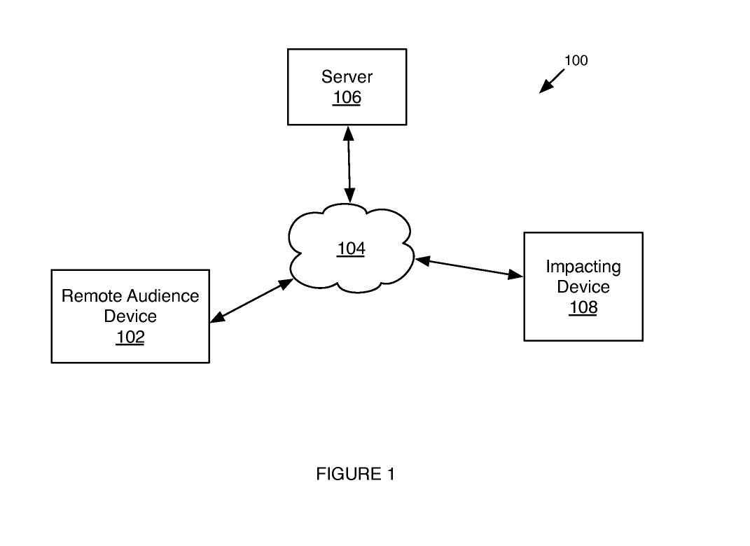

FIG. 1 is a somewhat simplified illustration of system 100 to provide remote audience participation to distract or confuse a show member according to one embodiment of the present disclosure. It should be understood that system 100 shown in FIG. 1 is for illustrative purposes only and that any other suitable system or subsystem could be used in conjunction with or in lieu of system 100 according to one embodiment of the present disclosure.

System 100 could include remote audience device 102, communication network 104, server 106, and impacting device 108 according to one embodiment of the present disclosure. Although only one remote audience device 102, communication network 104, server 106, and impacting device 108 is illustrated in FIG. 1, it should be understood that system 100 could include any number of suitable devices, networks, or servers.

Remote audience device 102 could receive an input from an audience member, observer, team fan, bystander, or show member to provide feedback or otherwise communicate or distract someone associated with a television show, webcast, video blog, theater show, sporting event, physically challenging event, team event, business event, performance, sales or marketing venture, or other form of entertainment. The input signal could be transmitted through communication network 104 and processed by server 106 to provide a corresponding output or otherwise communicate with impacting device 108.

The audience member using remote audience device 102 could be physically located at any suitable location including, for example, the place of the performance or at a remote location. In one embodiment, the audience member could use remote audience device 102 to provide information before the taping of an event. In other examples, the audience member could use remote audience device 102 as the performance occurs (e.g., in real-time) or in response to viewing a previously recorded performance. For example, the audience member could use remote audience device 102 to send a message, vote, communication, command, encouragement, coaching advice, or distraction to the performer as desired in order to, for example, show support or provide criticism of a particular performance or viewpoint of the performer. For example, the audience member's input could be used to provide instruction or otherwise influence a team sport, a team play or strategy, an individual play or strategy, increase/decrease physical intensity, increase/decrease mental challenges, or any suitable combination thereof. In other examples, the audience member could use remote audience device 102 to provide information before the taping of an event and again as the performance occurs (e.g., in real-time).

In one embodiment, remote audience device 102 could include a user terminal, stand-alone unit, network device, machine, wireless device, telephone system, smart phone, Internet portal, Intranet portal, remote access portal, hand-held unit, other suitable device or terminal, or any combination thereof. Remote audience device 102 could provide the audience with multiple options on how to communicate with the performer through, for example, a menu driven system, graphical user interface, buttons, switches, dials, other actuation systems, or any combination thereof.

In one example, the audience member could choose to send a signal, text message, vote, command, information, or other communication to the performer using remote audience device 102. In other examples, the audience member could send a signal to cause a light or other similar objects to light up, blink, or strobe, cause a sound or multiple sounds of varying volumes and pitch, or be counted against or for the performer. Multiple signals could be aggregated to find the relative popularity or unpopularity of the performer to trigger such distractions.

Communication network 104 could be any suitable network including, for example, a dedicated network connection, wire-line connection, wireless connection, Internet, Intranet, WiFi, LAN, WAN, mobile phone communication network, telecommunications network, other suitable communication systems, or any combination thereof. Communication network 104 could be coupled to or include any suitable number or types of connections between remote audience device 102, server 106, and impacting device 108. For example, a signal received from remote audience device 102 could be processed through the Internet to server 106 and finally to impacting device 108 by a wire-line connection. In another example, a signal received from audience device 102 could be processed through a mobile phone communications network to server 106 and finally to impacting device 108 by a WiFi network.

Server 106 could be configured to receive and process data, signals, query requests, and output any data, as necessary from any number of sources, including for example, remote audience device 102, communications network 104, and impacting device 108. Server 106 could generally include any server, group of servers, databases, memories, applications, software, computer programs, routines, other objects, or any combinations thereof. Server 106 could communicate with one or more communication networks such as, for example, a dedicated network connection, wire-line connection, wireless connection, Internet, Intranet, WiFi, LAN, WAN, mobile phone communication network, telecommunications network, other suitable communication systems, or any combination thereof.

In one embodiment, server 106 could process incoming information from remote audience device 102 to ascertain the number of votes, the number of text messages, or intensity or frequency of crowd noise attributed to a particular participant (or group of participants). Depending on the results, server 106 could send a signal to impacting device 108 to operate in a particular matter and subject the participant to a distraction.

Impacting device 108 could include one or more devices used to distract, impact, annoy, signal, text message, vote for/against, command, confusing patterns, lights, videos, movies, sounds, any other communication to the performer, or any combination thereof. For example, impacting device 108 could include lights, strobe lighting, digital display, lighted board, text board, digital display, computer, screen, cell phone, television, projector, speakers, water container, balloons, fireworks, fire, smoke, temperature controller, CD player, DVD player, other systems for distraction, or any combination thereof.

Impacting device 108 could be requested to distract the show participant in real-time or by tallying the number of votes or messages received from the audience and either begin or increase the intensity of the distraction accordingly. Suppose, for example, that during a live reality television program, the audience members could distract or otherwise confuse a participant of the show in real-time by calling a phone number or submitting information online. The participant (and perhaps fellow participants) could hear or view the message from the audience member as it is being submitted or shortly thereafter. In other cases, the call or online submission could trigger another distraction such as a digital display having a moving confusing pattern of some sort. With each additional call or online submission, the moving pattern could get more intense.

Suppose, in another example, that during a 10-minute segment of a television show, 300,000 audience members send text messages to server 106 for participant “A” and 1,500,000 audience members send text messages to server 106 for participant “B.” Server 106 correlates the text messages and requests impacting device 108 to distract participants “A” and “B” accordingly. Server 106 could request that participant “B” be subject to relatively more distractions (and perhaps in a relatively more intense level of distractions) than to participant “A” based on the number of text messages received for each participant (i.e., the greater the number of text messages, the greater level of distractions for the participant). In other examples, server 106 could request that impacting device 108 could provide a greater level of distractions for the participant with the least amount of text messages.

It may be advantageous to set forth definitions of certain words and phrases used in this patent document. The term “impacting device” includes any device to distract, confuse, impact, instruct, command, or otherwise positively or negatively affect participants of any event including, for example, a television show, webcast, video blog, theater show, sporting event, physically challenging event, team event, business event, performance, sales or marketing venture, or other form of entertainment. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure and the following claims.

What is claimed is:

1. A remote audience participation system comprising:
a server to process incoming information from one or more remote devices; and
an impacting device in communication with the server to output a distraction to a selected participant of a show based on the incoming information.

2. The system of claim 1, wherein the impacting device increases an intensity of the distraction as the amount of incoming information correlated to the selected participant increases.

3. The system of claim 1, wherein the impacting device decreases an intensity of the distraction as the amount of incoming information correlated to the selected participant increases.

4. The system of claim 1, wherein the impacting device comprises a digital display.

5. The system of claim 1, wherein the impacting device comprises a sound element.

6. The system of claim 1, wherein the server receives the incoming information from a telecommunications network.

7. The system of claim 1, wherein the server receives the incoming information from the Internet.

8. A remote audience participation system comprising:
a server to process incoming information from one or more remote devices; and
an impacting device in communication with the server to output a distraction in real-time to a selected participant of a show according to aggregate characteristics of the incoming information.

9. The system of claim 8, wherein the impacting device increases an intensity of the distraction as the amount of incoming information having a selected one of the aggregate characteristics increases.

10. The system of claim 8, wherein the impacting device decreases an intensity of the distraction as the amount of incoming information having a selected one of the aggregate characteristics increases.

11. The system of claim 8, wherein the impacting device increases a frequency of the distraction as the amount of incoming information having a selected one of the aggregate characteristics increases.

12. The system of claim 8, wherein the impacting device comprises at least one of: a digital display and a sound element.

13. The system of claim 8, wherein the incoming information comprises at least one of: a vote for the selected participant, a vote against the selected participant, and a text message for the selected participant.

14. The system of claim 8, wherein the server receives the incoming information from at least one of: a telecommunications network and the Internet.

15. For use with a television show, a remote audience participation system comprising:
a server to process incoming votes from one or more remote devices controlled by an audience member, wherein the server tallies the number of votes for a television participant; and
an impacting device in communication with the server to output a distraction to a selected participant according to the number of votes.

16. The system of claim 15, wherein the impacting device increases an intensity of the distraction to the selected participant as the tally of votes increases.

17. The system of claim 15, wherein the impacting device decreases an intensity of the distraction to the selected participant as the tally of votes increases.

18. The system of claim 15, wherein the impacting device comprises at least one of: a digital display and a sound element.

19. The system of claim 15, wherein the server receives the incoming information at least one of: a telecommunications network and the Internet.

20. The system of claim 15, wherein the incoming information comprises at least one of: a vote for the selected participant and a text message for the selected participant.
